(19) United States
(12) Patent Application Publication
(10) Pub. No.: US 2002/0123878 A1
(43) Pub. Date: Sep. 5, 2002

(54) Mechanism for internationalization of web content through XSLT transformations

(75) Inventor: Laura Lee Menke, Rochester, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY (US)

(21) Appl. No.: 09/777,158

(22) Filed: Feb. 5, 2001

(51) Int. Cl. G06F 17/28

(52) U.S. Cl. 704/2

(57) ABSTRACT

A method for internationalizing content of an electronic document, which may be mbodied on a computer readable medium, wherein the method includes the steps of ssociating a predefined parameter with content in a source web page to be translated, and inserting entries corresponding to translations of the content in the source web page into n indexable dictionary file. The method further includes application of a dictionary riven stylesheet to the source web page in order to retrieve a translation of a particular ext string from the indexable dictionary file.

### BACKGROUND OF THE INVENTION

1. Field of the Invention:

The present invention relates to a method and/or apparatus for internationalizing textual content of an electronic document.

2. Background of the Related Art:

The significant growth of the Internet has made mass quantities of information available to persons around the world. However, the presentation of information in the respective language of each individual requires that each page of information on the Internet be translated to the desired target language, e.g., the preferred language of the respective user, if the information is to be internationally available. Therefore, various methods and programs currently exist for converting the textual content of a web page from a first language to a target language, which is generally referred to as internationalization.

Publicly available software packages and/or operating systems generally provide features that may be used in conjunction with development languages in order to address internationalization issues. For example, Microsoft's traditional Windowsg) operating system implements resource files that may be used in conjunction with software development languages, such as Borland's C++ and other similar languages, to internationalize web page content. However, traditional resource files are known to not be universally available for all development languages, and therefore, have limited application and usefulness. In particular, resource files in early Windows operating systems are not offered for the JAVA™ language, which has recently become one of the most popular programming languages.

Another disadvantage of traditional resource files is that the development environments that generate user interfaces generally rely on resource file capabilities by marking the application program with marker characters. However, if a developer editing the application unintentionally disturbs a marker, it will generally cause the program to cease working entirely.

Further, traditional resource files generally have not incorporated object-oriented characteristics, and therefore are not completely compatible with the currently desirable object oriented languages and functions such as inheritance, encapsulation and polymorphism. In view of the current widespread acceptance and preference of object oriented programming languages, limitations resulting in incompatibility with object oriented systems are wholly undesirable.

Aside from non-object orientated internationalization techniques, object oriented languages, such as the well-known program Java™, generally provide resource bundles for undertaking translation operations. These resource bundles may contain locale-specific objects, and therefore, when an object oriented web page needs a locale-specific resource, e.g., an element translation, it can load it from the resource bundle that is appropriate for the user's locale/preference. This allows for object oriented program code to be written that is largely independent of the user's locale by isolating most, if not all, of the locale-specific information within the resource bundles. However, resource bundles suffer from the disadvantage of being difficult to maintain for a typical web site, as the supporting Java™ code must be modified and/or rewritten each time the content of a web page changes. This characteristic alone makes the use of resource bundles undesirable for internationalization purposes, as any textual change whatsoever in a web page will often require the programmer to modify the supporting Java code.

Another technique for presenting translated web pages, both through object and non-object oriented programming, is to create separate web pages for each individual language. However, this technique is extremely time and resource intensive, as creation and maintenance of web pages in multiple languages is all but impossible given the pure quantity of information in the Internet.

Therefore, in view of the clear deficiencies of present internationalization techniques, there exists a need for an efficient method for internationalizing web content that is generally compatible with current web page programming schemes.

### SUMMARY OF THE INVENTION

The present invention provides a method for internationalizing content of an electronic document, wherein the method includes the steps of associating a predefined parameter with content in a source web page to be translated, and inserting entries corresponding to translations of the content in the source web page into an indexable dictionary file. The method further includes application of a dictionary driven stylesheet to the source web page in order to retrieve a translation of a particular text string from the indexable dictionary file.

The present invention fuirther provides a method for translating text in an electronic document including the steps of inserting a predetermined parameter into a source code of the electronic document, the predetermined parameter indicating that an associated portion of text is to be translated. The method further includes the steps of inserting an entry representing a translation of the associated portion of text into an electronic dictionary file, and applying a dictionary driven generic stylesheet to the electronic document in order to retrieve the translation of the associated portion of text.

The present invention firther provides a computer readable medium storing a software program that, when executed by a computer, causes the computer to perform a method including the steps of associating a predefined parameter with content in a source web page to be translated, and inserting entries corresponding to translations of the content in the source web page into an indexable dictionary file. The method further includes application of a dictionary driven stylesheet to the source web page in order to retrieve a translation of a particular text string from the indexable dictionary file.

The present invention further provides a computer readable medium storing a software program that, when executed by a computer, causes the computer to perform a method including the steps of inserting a predetermined parameter into a source code of the electronic document, the predetermined parameter indicating that an associated portion of text is to be translated. The method further includes the steps of inserting an entry representing a translation of the associated portion of text into an electronic dictionary file, and applying a dictionary driven generic stylesheet to the electronic document in order to retrieve the translation of the associated portion of text.

### BRIEF DESCRIPTION OF THE DRAWINGS

So that the manner in which the above recited features, advantages and objects of the present invention are attained can be understood in detail, a more particular description of the invention briefly summarized above may be had by reference to the embodiments thereof, which are illustrated in the appended drawings. It is to be noted, however, that the appended drawings illustrate only typical and/or exemplary embodiments of the present invention, and are therefore, not to be considered limiting of its scope, as the invention may admit to other equally effective alternative embodiments.

FIG. 1 illustrates an exemplary XSLT stylesheet of the present invention.

FIG. 2 illustrates an exemplary hardware configuration of the present invention.

FIG. 3 illustrates an exemplary flowchart of the present invention.

FIG. 4 illustrates an exemplary flowchart further detailing step 31 of FIG. 3.

FIG. 5 illustrates an exemplary flowchart further detailing step 35 in FIG. 3.

FIG. 6 illustrates an exemplary code set of a source document.

FIG. 7 illustrates an exemplary code set for a dictionary.

FIG. 8 illustrates an exemplary code set of a translated target document.

FIG. 9 illustrates an exemplary display of the code set of FIG. 8.

### DETAILED DESCRIPTION OF THE PREFERRED EMBODIMENT

Since one or more embodiments of the present invention may utilize markup-type languages, a brief introduction into such languages may be helpful. However, it is understood that the brief introduction into markup-type languages is intended only as an illustration and not an exhaustive recitation. Further, although embodiments of the present invention are described with respect to markup-type languages, other languages may be used to support the present invention and are expressly contemplated in the present invention.

Most Internet or web applications deal with data that is formatted in a markup language, such as Extensible Markup Language (XML), Hypertext Markup Language (HTML), Standard Generalized markup Language (SGML), and/or other known markupROC920000259US type languages. HTML and XML, both of which are subsets of SGML, are the primary languages used in current web applications. HTML may be generally described as a set of markup symbols or codes inserted into a file that is intended for display on an Internet or web application, such as a web browser page. The HTML symbols and codes, which 5 are generally referred to as markup, indicate the manner in which the content of the file is to be displayed to a user. Each individual markup code is generally referred to as an element or a tag, which may occur singly or in pairs if the markup includes a time display element or other additional display parameter. XML may be generally described as a flexible way to create common information formats, wherein both the information (data) and the display fornat of the information may be shared through various applications such as the World Wide Web (WWW), intranets, and other computer network-type systems.

Although both HTML and XML contain markup symbols that describe the contents of a web page or file, HTML describes the contents only in terms of how it is to be displayed and interacted with. Alternatively, XML describes the content on terms of what data is being described. For example, in HTML “X” may represent a parameter such as the beginning of a new paragraph, while in XML “X” may represent that the data following the “X” represents a phone number. Therefore, an XML file can be processed by a program as purely data or it can be stored with similar data on another computer or, in similar fashion to HTML, it can be displayed. XML is referred to as extensible as a result of the markup symbols being unlimited and self-defining, unlike HTML. However, although HTML and XML offer distinct advantages, they may be used together in a single page to afford the benefits of both markup languages.

When the content of a web page must be translated into another language, often termed a target language, a standard XML-based transformation mechanism may be used to replace the an original textual portion of a web page with text corresponding to the target language. One common transformation mechanism that may be used to execute this transformation operation is an Extensible Stylesheet Language Transformation (XSLT). Extensible Stylesheet Language (XSL) is a programming language for creating stylesheets, wherein the XSL code describes how data sent over the web using the XML is to be presented to the user. Therefore, XSL gives developers the tools to describe exactly which fields in an XML file to display, and frther, exactly where and how to display these fields. Further, as with most style sheet-type languages, XSL can be used to create a style definition for one XML document that may be reused for various other XML documents. The XSLT's are a standard way to describe how to transform and/or change the structure of a first XML document into a second XML document with a different structure. Therefore, the XSLT determines how a first XML document will be reorganized into a second document, which may also be an XML document. The XLST is used to describe how to transform the source tree or data structure of the first XML document into the result tree for the new XML document, which is generally of a completely different structure than the first XML document.

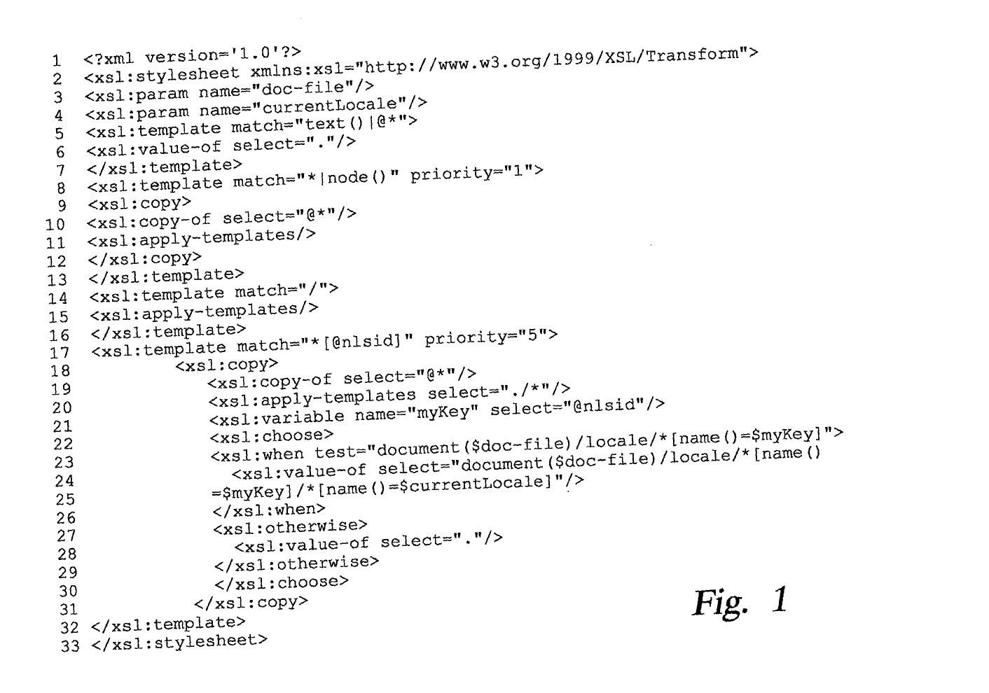

The driving code for the XSLT is generally referred to as a stylesheet, which is briefly mentioned above. The stylesheets can be combined with an XSL stylesheet or be used independently. However, when a simple XSLT is used to translate text in a web page, one XSLT stylesheet is typically used for each language pairing, as the transformation to each individual target language requires a separate stylesheet in order to execute the transformation. One embodiment of the invention avoids the use of multiple stylesheets for multiple target languages through the implementation of a dictionary driven generic XSLT stylesheet in order to control dynamic replacement of translatable portions of text within the source page, as shown in FIG. 1. The implementation of the generic XSLT stylesheet shown in FIG. 1 allows for application of the generic stylesheet to various other situations simply through the specification of a new dictionary.

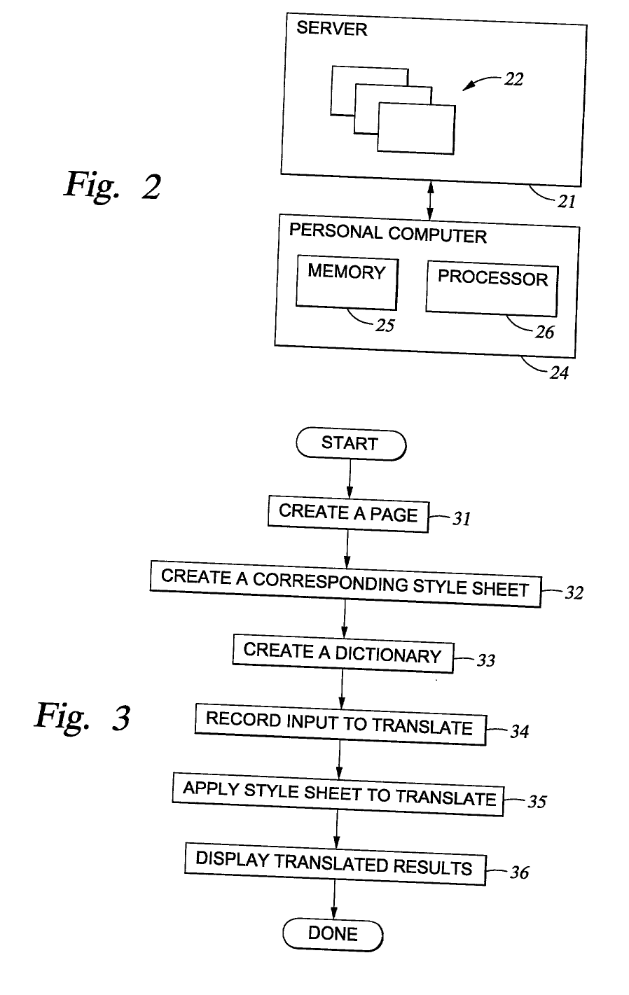

An exemplary hardware configuration of the present invention is shown in FIG. 2. In the exemplary configuration a server 21 may have a plurality of electronic documents 22 stored therein. These documents may be in the form of HTML pages, or in other suitable forms of data representation. Server 21 may be connected to a personal computer 24 of a user through a communications link 23. The communications link may be through the Internet, an intranet, or other network-type system designed to allow computer equipment to share data in a bidirectional manner. Personal computer 24 generally includes a processor 26 and a memory 25. Memory 25 may operate to store programs therein, which may be retrieved and executed by processor 26.

In this configuration, if the user of personal computer 24 desires to view a document 22 that is not in a language that the user can read, then the specific document must be translated for viewing by the user. A stylesheet, which may be stored in memory 25 or on server 21, may be applied to the document to be translated in order to determine the appropriate translation of terms and/or phrases in the document. The determination of the appropriate translation generally includes indexing into a dictionary file to find a match for terms to be translated. The dictionary may be stored on server 21 or in memory 25. Upon finding a match, an appropriate translation may be selected from sub-entries of the matched term. The appropriate translation is then displayed in a new page that the user may be able to read.

FIG. 3 illustrates a flowchart of an exemplary method 30 of an embodiment of the present invention. Method 30 begins with step 31, where the source page is generated. Step 31 generally involves the markup language progranmiing of the source page, and therefore, includes insertion of specific parameters, tags, and/or elements necessary to support the method of the present invention, which will be further discussed herein. At step 32 a generic XSLT stylesheet corresponding to the source page is created, however, as noted above, the versatility of the present invention allows for the re-use of the generic style sheet. At step 33 a dictionary corresponding to the source page is created or selected from a library of dictionaries, wherein the created/selected dictionary includes entries corresponding to the desired language pairs for the source page.

Steps 31 through 33 generally correspond to the setup portion of method 30, as these steps generally take place during the creation/programnuing phase of a page of data. Although the setup steps are illustrated as being sequential in FIG. 3, it is understood that the steps of FIG. 3, as well as the steps of the other Figures illustrated herein, are not limited to the sequential order illustrated in the respective Figures. For example, the page may be created at step 31, and then the dictionary may be created prior to the stylesheet being created, along with other combinations.

The intemationalization/translation steps begin with step 34, where method 30 receives an input indicating that the textual portion of the source page is to be translated to a target language. Upon receiving the input indicating that a translation is requested, method 30 applies the generic stylesheet to the source page at step 35. This step includes translating each textual element of the source page in accordance with the parameters set forth in the generic stylesheet through the use of the selected/created dictionary from step 33. Thereafter, the translated results are displayed to the user at step 36.

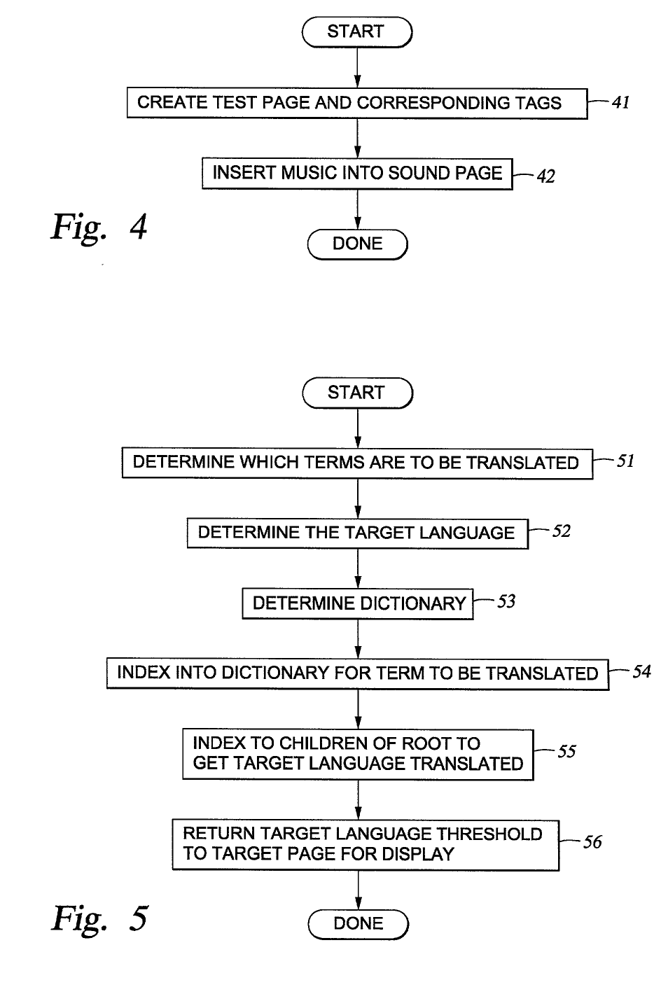

Step 31 of the present exemplary embodiment may be fuirther detailed as shown in the exemplary flowchart of FIG. 4. Step 41 illustrates the step of creating the actual text and corresponding markup parameters of the original page. This step may generally correspond to the markup language programming step for a page of web data, for example. Step 42 illustrates the placement of an NLSID in the markup code corresponding to each of the text parameters that are to be translated into the target language. The NLSID operates as an indicator to the stylesheet that the parameter associated with the NLSID, e.g., the text, is a parameter that is to be translated by the stylesheet. Although an NLSID is disclosed in the present exemplary embodiment, the present invention contemplates using essentially any attribute that may be associated with an element whose contents are to be translated. Therefore, during the programming stage, each elements contents that are to be translated will generally have an NLSID associated with the element in order to indicate to the stylesheet that the particular element's contents are to be translated into the target language.

Step 32 of the present exemplary embodiment generally includes generating the generic stylesheet. The stylesheet is the basic transformation mechanism of markup language programming. The stylesheet essentially operates to transform source document text into target language text via an indexing operation with a selected dictionary. Therefore, the stylesheet is generally configured to determine the target language, determine the appropriate dictionary, determine which terms in the source page must be translated, and index into the appropriate dictionary to find the translated terms that correspond to the terms designated for translation. The configuration of the stylesheet is generally accomplished at the progranuning stage in view of the configuration of the source page. Alternatively, if the source page is of a relatively standardized format, then a generic stylesheet may be used to translate the source page. In this circumstance the step of creating a stylesheet may be eliminated, as a previously created generic stylesheet is used. However, if the reused generic stylesheet includes dynamic parameters, such as a dictionary designation, then the dynamic parameters may be modified in the reused stylesheet in order to reflect the particulars of the current implementation.

Step 33 of the present exemplary embodiment generally includes creating the dictionary to be used for the translation of the source page. In similar fashion to the stylesheet, the dictionary may not need to be created for each individual source page, as a single dictionary may support translation functions for a plurality of pages, if the appropriate entries are resident in the particular dictionary. In configuration, the dictionary may generally include root elements corresponding to locales, and children of the root elements corresponding to the textual parameters within the source page to be translated. Further, the sub-elements of the children may represent translated text from the source page. The sub-elements may include numerous entries, wherein each entry may correspond to another language translation of the corresponding root text. As noted above, the stylesheet may index into the dictionary to find the term to be translated, the root and/or sub-elements, and then locate the appropriate sub-element, which represents the translation of the term in the target language.

Step 34 of the present exemplary embodiment generally includes receiving input corresponding to an instruction to translate a portion of text. The actual portion of text to be translated may be a single term in a web page, an entire web page, or many web pages. Inasmuch as the present exemplary embodiment is related to translation of text within web pages, the actual input instruction for translation may correspond to a user selection in a particular web page corresponding to a request to translate the web page, or an element therein, into a particular target language. Alternatively, the input instruction may correspond to an instruction generated by a web browser. More particularly, since most web browsers such as Netscape Navigator® and Microsoft Internet Explorer® include a “user preferences” option, the respective browser may be programmed and/or configured to generate the input instruction in order to display a web page to a user in a preferred language stored in the user preferences.

Once the input instruction to translate is received, then method 30 continues to step 35, where the stylesheet is applied to the page to be translated. FIG. 5 illustrates a general flowchart of the steps corresponding to the application of the stylesheet. At step 51 the stylesheet determines what textual portions of the source page are to be translated. In the present exemplary embodiment this determination is made through the use of the above-discussed “specific parameters” that may be inserted into the source page at the programming/creation stage shown in step 31 of FIG. 3. More particularly, the present exemplary embodiment uses an NLSID in the source page to identify the terms and/or textual portions of the page that are to be translated. As such, during the creation stage of a particular page, the programmer may associate an NLSID with each term and/or portion of text within the page that is to be translated. Therefore, the determination of which terms are to be translated in step 51 may generally correspond to searching through the source page for those terms and/or textual portions of the page that have an NLSID associated therewith. Although an NLSID is disclosed as the parameter indicating that a particular term within the source page is to be translated, the present invention contemplates that other parameters may be used in the markup language to indicate that a term in the source page is to be translated.

The application of the stylesheet continues with step 52, where the appropriate target language is determined. As briefly discussed above, the target language may be received from the web browser in accordance with the preferred language of the user stored in the browsers preferences file. Alternatively, the preferred language may be determined through a user input or an input from a third party source, such as another server. Regardless of the source of the preferred language parameter, the preferred language parameter is passed to the stylesheet for use in the translation process, and in particular, the preferred language parameter is used to set and/or determine the target language.

The application of the stylesheet continues with step 53, where the stylesheet determines what dictionary is to be used for the translation of the particular source page. This determination can be made through reference to the source page, wherein a dictionary may be specified at the programming stage. Alternatively, the dictionary may be specified after the programming of the source page and inserted into the stylesheet programming code itself. Once the appropriate dictionary has been specified, this parameter is passed to the stylesheet for use in translating the text of the source page.

Once the target language and the dictionary parameters have been determined and passed to the stylesheet, the stylesheet begins a translation process represented by steps 54-56. The translation process begins at step 54 with the stylesheet indexing into the selected dictionary looking for a match for the term or phrase to be translated. The stylesheet first locates the appropriate root in the dictionary, and then searches for a match to the appropriate NLSID corresponding to a term or phrase in the source page to be translated in the elements of the root. When the NLSID corresponding to the term or phrase to be translated is matched to a root entry in the dictionary, then the stylesheet begins to index into the sub-elements of the root with the term to be translated. Upon locating the term to be translated, the stylesheet indexes into the children of the term entries with the preferred language parameter, as shown in step 55.

Therefore, the stylesheet first indexes into the dictionary to find a root entry. Thereafter the stylesheet finds a sub-root element corresponding to the NLSID. Once the sub-root entry is found, then the stylesheet begins to index into the entries of the sub-root, which represent the specific text from the source page to be translated. Upon locating a match of the text to be translated, the stylesheet locates a sub-entry corresponding to the translation of the text in the target language. When a match is determined in the sub-entries, then the translation of the term or phrase from the source page has been located. At this point the translated term or phrase is returned by the stylesheet to the target page in the target language at step 56.

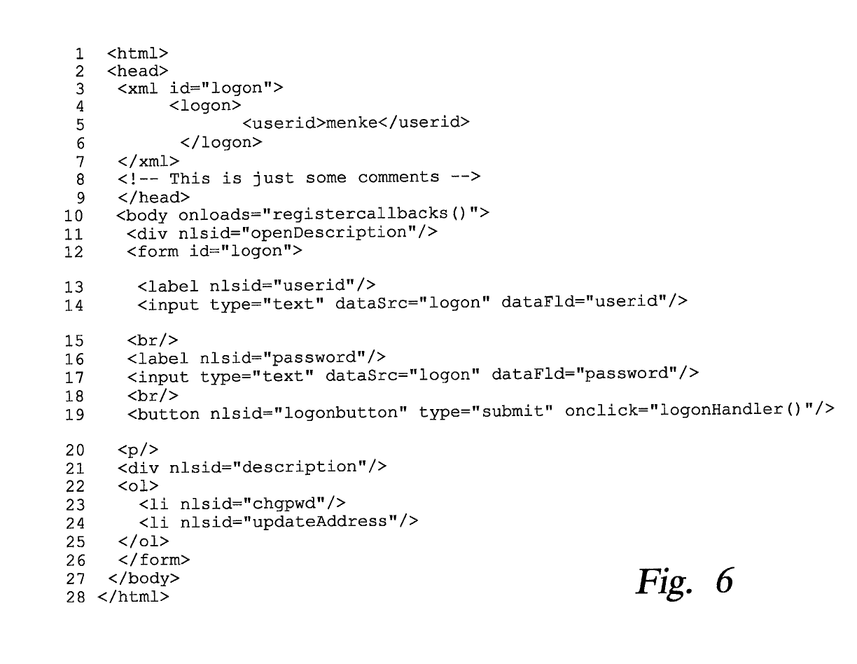

In order to illustrate the internationalization process of the present invention, the supporting markup code for an exemplary HTML/XML source document is shown in FIG. 6. The source document, although simplified substantially for illustration purposes, illustrates text and phrases in the source language that a user would like to have translated into a target language. The code in FIG. 6 begins with introductory identification statements and a data island in the head statement, which is the first eight lines of the code. Although data island functions are generally supported only by Microsoft's Internet Explorers program, similar data island type finctions are available for other browser programs. The body of the code begins at line 10 with a Java script function related to the outside file “registercallback.” The first DIV statement is shown in line 11 and includes an NLSID. As a result of the NLSID, the contents from the dictionary will be inserted into this DIV tag upon application of the stylesheet to the source page. Line 12 illustrates a “form id” tag for a normal HTML form, and line 13 illustrates a normal HTML “label.” However, since nothing is defined for the “label” of line 13, this parameter will be pulled from the dictionary as a result of the NLSID being associated with the label. Line 14 is an “input tag having the data source field set to Alogon,” which indicates the input filed should be loaded with the contents of the data source, e.g., from the statement “xml id=logon.” Lines 16 and 17 illustrate additional “labels” that will be pulled from the dictionary, as the fields are not expressly specified in the statement. Lines 21 through 24 illustrate a final field of textual parameters to be displayed, wherein the field includes an NLSID, and therefore, will be translated from the dictionary. Lines 25 through 28 simply close and/or end the code segments.

Further, although the exemplary HTML/XML document only lists a few textual parameters to be translated, the embodiments of the present invention are not limited to any particular number of terms. In fact, the present invention may be implemented with simple pages such as the present example, but also implemented in pages including hundreds, thousands, and even millions of terms that must be translated. Therefore, the methods of the present invention are scalable to translate any number of terms in one or more source pages.

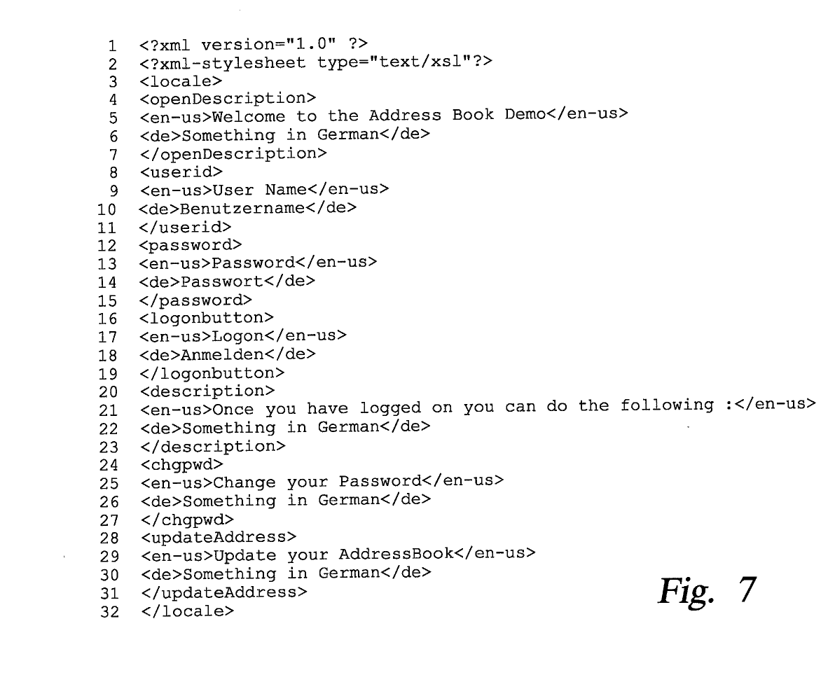

FIG. 7 illustrates exemplary markup code supporting the dictionary for the present example translation. The first two lines of the code represent setup statements necessary to support the Java code. Line 3 illustrates a root element in the dictionary that may be indexed by the stylesheet. Lines 4, 8, 12, 16, 20, and 28 represent elements of the root element in the dictionary entries, wherein these elements correspond to the text to be translated from the source document. These elements of the root element are the elements indexed in the stylesheet's search. The two lines below each of the respective elements of the root represent the available translations for that particular element, which may also be indexed in accordance with he preferred language/target language parameter. For example, lines 5 and 6 represent the English and German translations of the element listed in line 4. The root element may include any number of sub-elements thereunder, and each sub-element may have any number of elements corresponding to translations. As such, the dictionary is infinitely expandable.

FIG. 1 illustrates an exemplary stylesheet for the present invention. Line 1 indicates the XML version of the present code and line 2 indicates the namespace for the code. Lines 3 and 4 define parameters that will be used by the stylesheet, which are generally set by the browser and/or supporting Java code. The parameter set in line 3 generally represents the dictionary that will be used by the current stylesheet, while the parameter set in line 4 represents the locale that will be used when translating text. Although these parameters are listed in the code of FIG. 1, these parameters may be inserted by additional code sets, such as a Java code set programmed to determine and insert these parameters into the stylesheet. The parameter “doc-file” specified in line 3, which corresponds to the dictionary to be used, generally corresponds to a stylesheet parameter set in a doc-type file upon initialization. Lines 5, 8, and 17 represent template match statements, which are applied in a prioritized order. As such, the template statement in line 17 is generally applied first, while the template statements in lines 5 and 8 will be applied thereafter, as line 17 has a higher priority designation. Each of the template match statements are applied to nodes that have not yet been touched. Therefore, if the template match statement of line 17 touches a particular node, then neither of the statements in lines 5 or 8 will touch that particular node. The template match statement in line 5 operates to copy all of the text that are not actually nodes and attributes to the destination/target document. The template statement in line 8 copies the text of all of the untouched nodes to the destination document. The template statement of line 17 operates to match all elements that have the attribute NLSID. In this particular matching process, first the respective element is copied per the instruction in line 18. Then all of the attributes in the original parameter being translated are copied to the destination file per linel9. Thereafter, the template instruction is applied to all nodes below in lines 20-29. With particularity, line 21 indicates that the value of the NLSID is retrieved, and a test is then conducted at line 22. Lines 23 through 26 represent an “xpath” expression that is configured to open the specified doc-type file (the specified dictionary) and search for the root element. Upon finding the root element, the code looks for elements of the root that have a name that matches the particular NLSID copied into “mykey.” If a match is found, then the matching element is inserted into the destination document. This insertion corresponds to inserting a translation into the destination document. However, if no translation/match is found, then the element is left alone, and the remainder of lines 28 through 33 take care of copying the information from the source to the destination file and/or page, in similar fashion to the template statements of lines 5 and 8.

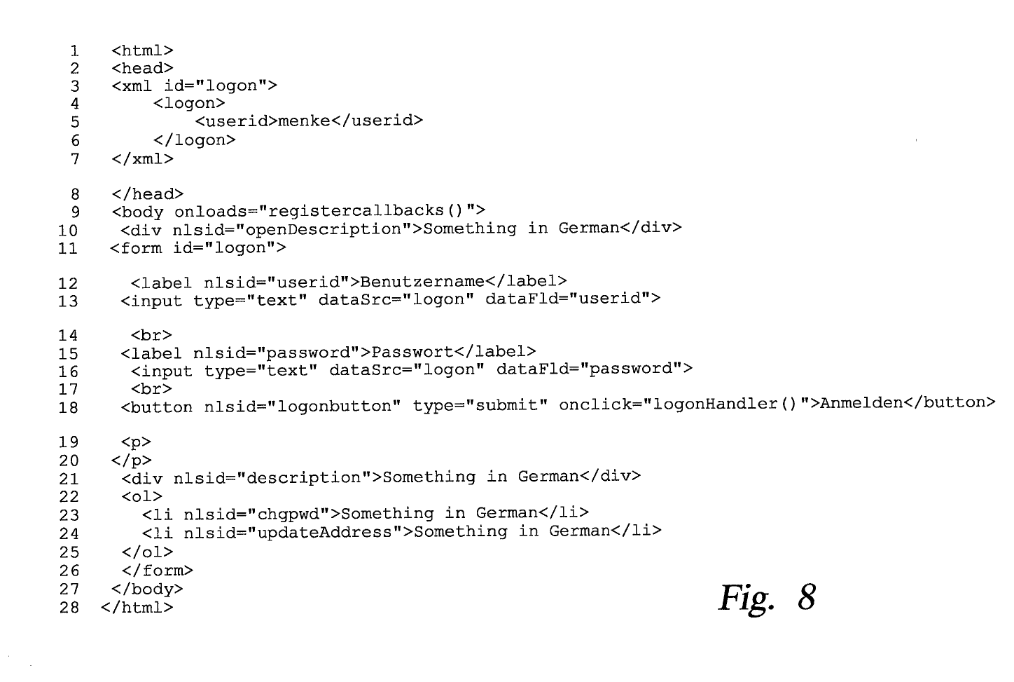

FIG. 8 represents an exemplary destination and/or target code. The first 8 lines again show the header and data island. The remaining lines show the parameters from the original source page, wherein each parameter that had an NLSID associated therewith now has a translation of that particular parameter in the destination page. Further, all of the attributes associated with these parameters have also been copied to the destination page, although not expressly shown by the results code. An example of the translation may be had by reviewing line 13 in FIG. 6, which corresponds to the “userid” field. Line 12 of the results code illustrates that the term “userid” from the source document has been translated to the German equivalent of “Benutzemame,” in accordance with line 10 of the dictionary in FIG. 7.

Therefore, through the use of the generic stylesheet of the present invention, multiple pages of web information may be translated using a single stylesheet, wherein the stylesheet need not be reconfigured and/or reprogrammed for application to each of the pages. Further, a single dictionary may support the translation functions for each of the individual pages. As such, the maintenance and programming overhead for web pages associated with internationalization is substantially reduced, as the page need only be created once. If the page is modified after creation and implementation, then updating of the dictionary with any new terms is the only step necessary to support internationalization of the updated page. No stylesheet modifications are necessary.

Additionally, although the present invention is generally described with respect to a program that may be executed on either a remote computer or a local user computer, the present invention contemplates implementing/storing the method of the present invention on a computer readable medium as a program-type file. In this configuration a processor or other processing-type device may retrieve the program from the computer readable medium and execute the instructions of the method. Furthermore, the present invention may be embodied on a remote computer readable medium and then transmitted to a local user for execution, through, for example, a download type operation.

While the foregoing embodiments are directed to the preferred embodiment of the present invention, other and further embodiments of the invention may be devised without departing from the scope thereof, wherein the scope thereof is determined by the metes and bounds of the claims that follow.

What is claimed is:

1. A method for internationalizing content of an electronic document comprising:
associating a predefined parameter with content in a source web page to be translated; and
inserting entries corresponding to translations of the content in the source web page into an indexable dictionary file, wherein a dictionary driven stylesheet may be applied to the source web page in order to retrieve a translation of a particular text string from the indexable dictionary file.

2. The method of claim 1, wherein the associating step comprises associating an NLSID with textual content in the source web page to be translated, the NLSID being associated with the textual content in markup language code supporting the source web page.

3. The method of claim 1, wherein inserting entries comprises:
locating a root entry corresponding to the source web page;
inserting a sub-root entry corresponding to a term to be translated; and
inserting at least one translation entry as a sub-entry of the sub-root entry.

4. The method of claim 1, wherein the application of the dictionary driven stylesheet comprises:
locating textual content having the predefined parameter associated therewith in the source web page;
indexing into the dictionary file to find a root entry corresponding to the predefined parameter;
indexing into sub-root entries to find an entry corresponding to the textual content; and indexing into children of the sub-root entries to find a translation entry for textual content.

5. The method of claim 4, wherein the step of indexing into the children of the subroot entries further comprises:
determining a target language; and
indexing into the children of the sub-root entry to find a child entry corresponding to the target language.

6. The method of claim 4, wherein the step of indexing into the dictionary file further comprises indexing into the dictionary file to find a root entry that matches an NLSID associated with the textual content.

7. The method of claim 1, the method further comprising the steps of:
generating the indexable dictionary file with a markup language; and
generating the generic dictionary driven stylesheet with a markup language.

8. The method of claim 7, wherein the indexable dictionary file further comprises at least one root entry corresponding to an NLSID associated with a portion of text to be translated from the source web page, at least one sub-root entry corresponding to the text to be translated, and at least one child sub-root entry corresponding to the available translations for the portion of text.

9. The method of claim 7, wherein the dictionary driven stylesheet further comprises at least one template match operation configured to copy all untouched nodes from a source document to a destination document, and at lest one template match statement configured to translate text in the source document via access into the indexable dictionary file.

10. The method of claim 1, wherein the electronic document further comprises a web page.

11. The method of claim 1, wherein the stylesheet further comprises a generic dictionary driven stylesheet that may be reused for various applications.

12. A method for translating text in an electronic document comprising:
inserting a predetermined parameter into a source code of the electronic document, the predetermined parameter indicating that an associated portion of text is to be translated;
inserting an entry representing a translation of the associated portion of text into an electronic dictionary file; and
applying a dictionary driven generic stylesheet to the electronic document in order to retrieve the translation of the associated portion of text.

13. The method of claim 12, wherein the step of inserting a predetermined parameter comprises:
determining what portions of text are to be translated in a source document; and
associating an NLSID with the portions of text determined to be translated in the source document, the NLSID being associated with the portions of text to be translated in the source code of the source document.

14. The method of claim 12, wherein the source code further comprises a markup language code set.

15. The method of claim 14, wherein the markup language code set further comprises at least one of a hypertext markup language code set and an extensible markup language code set.

16. The method of claim 12, wherein the step of inserting an entry into an electronic dictionary file flurther comprises:
locating a root entry in the electronic dictionary file corresponding to the predetermined parameter;
inserting a sub-root entry corresponding to the portion of text to be translated; and
inserting at least one sub-root child entry, wherein each sub-root child entry corresponds to a translation of the portion of text in a particular language.

17. The method of claim 16, wherein the locating step fuirther comprises locating a root entry in the electronic dictionary file corresponding to an NLSID associated with the portion of text to be translated.

18. The method of claim 12, wherein the step of applying a dictionary driven generic stylesheet comprises:
determining at least one portion of text in a source document having the predetermined parameter associated therewith;
searching in the electronic dictionary file to find a root entry corresponding to the predetermined parameter;
searching in sub-root entries of the electronic dictionary to find an entry corresponding to the portion of text to be translated; and
searching in children of the sub-root entries in the electronic dictionary to find a translation entry for textual content.

19. The method of claim 18, wherein determining at least one portion of text having the predetermined parameter associated therewith furrther comprises indexing into the source code of an electronic document to locate text having an NLSID associated therewith.

20. The method of claim 18, wherein searching in the electronic dictionary file to find a root entry further comprises indexing into the electronic dictionary file with an NLSID to find a root entry match.

21. The method of claim 18, wherein searching in children of the sub-root entries further comprises indexing into the children of the sub-root entries with a preferred language parameter to find a match.

22. A computer readable medium storing a software program that, when executed by a computer, causes the computer to perform a method comprising:
associating a predefined parameter with content in a source web page to be translated;
inserting entries corresponding to translations of the content in the source web page into an indexable dictionary file; and
applying a generic dictionary driven stylesheet to the source web page, wherein the application of the stylesheet operates to retrieve a translation of a particular text string from the indexable dictionary file.

23. The computer readable medium of claim 22, wherein the associating step comprises associating an NLSID with textual content in the source web page to be translated, the NLSID being associated with the textual content in markup language code supporting the source web page.

24. The computer readable medium of claim 22, wherein inserting entries comprises:
locating a root entry corresponding to the source web page;
inserting a sub-root entry corresponding to a term to be translated; and
inserting at least one translation entry as a sub-entry of the sub-root entry.

25. The computer readable medium of claim 22, wherein applying a generic dictionary driven stylesheet comprises:
searching through the source web page to find textual content having the predefined parameter associated therewith;
indexing into the dictionary file to find a root entry corresponding to the predefined parameter;
indexing into sub-root entries to find an entry corresponding to the textual content; and
indexing into children of the sub-root entries to find a translation entry for textual content.

26. The computer readable medium of claim 25, wherein the step of indexing into the children of the sub-root entries further comprises:
determining a target language; and
indexing into the children of the sub-root entry to find a child entry corresponding to the target language.

27. The computer readable medium of claim 25, wherein the step of indexing into the dictionary file fiither comprises indexing into the dictionary file to find a root entry that matches an NLSID associated with the textual content.

28. The computer readable medium of claim 22, the method further comprising the steps of:
generating the indexable dictionary file with a markup language; and
generating the generic dictionary driven stylesheet with a markup language.

29. The computer readable medium of claim 28, wherein the step of generating the indexable dictionary file firrther comprises creating the indexable dictionary file, wherein the dictionary file includes at least one root entry corresponding to an NLSID associated with a portion of text to be translated from the source web page, at least one sub-root entry corresponding to the text to be translated, and at least one child sub-root entry corresponding to the available translations for the portion of text.

30. The computer readable medium of claim 28, wherein the step of generating the generic dictionary driven stylesheet further comprises creating the generic dictionary driven stylesheet, wherein the generic dictionary driven stylesheet includes at least one template match operation configured to copy all untouched nodes from a source document to a destination document, and at lest one template match statement configured to translate text in the source document via access into the indexable dictionary file.

31. A computer readable medium storing a software program that, when executed by a processor, causes the processor to perform a method comprising:
inserting a predetermined parameter into a source code of the electronic document, the predetermined parameter indicating that an associated portion of text is to be translated;
inserting an entry representing a translation of the associated portion of text into an electronic dictionary file; and
applying a dictionary driven generic stylesheet to the electronic document in order to retrieve the translation of the associated portion of text.

32. The computer readable medium of claim 31, wherein the step of inserting a predetermined parameter comprises:
determining what portions of text are to be translated in a source document; and
associating an NLSID with the portions of text determined to be translated in the source document, the NLSID being associated with the portions of text to be translated in the source code of the source document.

33. The computer readable medium of claim 31, wherein the source code further comprises a markup language code set.

34. The computer readable medium of claim 33, wherein the markup language code set fiuther comprises at least one of a hypertext markup language code set and an extensible markup language code set.

35. The computer readable medium of claim 31, wherein the step of inserting an entry into an electronic dictionary file fiuther comprises:
locating a root entry in the electronic dictionary file corresponding to the predetermined parameter;
inserting a sub-root entry corresponding to the portion of text to be translated; and
inserting at least one sub-root child entry, wherein each sub-root child entry corresponds to a translation of the portion of text in a particular language.

36. The computer readable medium of claim 35, wherein the locating step further comprises locating a root entry in the electronic dictionary file corresponding to an NLSID associated with the portion of text to be translated.

37. The computer readable medium of claim 31, wherein the step of applying a dictionary driven generic stylesheet comprises:
determining at least one portion of text in a source document having the predetermined parameter associated therewith;
searching in the electronic dictionary file to find a root entry corresponding to the predetermined parameter;
searching in sub-root entries of the electronic dictionary to find an entry corresponding to the portion of text to be translated; and
searching in children of the sub-root entries in the electronic dictionary to find a translation entry for textual content.

38. The computer readable medium of claim 37, wherein determining at least one portion of text having the predetermined parameter associated therewith firther comprises indexing into the source code of an electronic document to locate text having an NLSID associated therewith.

39. The computer readable medium of claim 37, wherein searching in the electronic dictionary file to find a root entry fuirther comprises indexing into the electronic dictionary file with an NLSID to find a root entry match.

40. The computer readable medium of claim 37, wherein searching in children of the sub-root entries fuirther comprises indexing into the children of the sub-root entries with a preferred language parameter to find a match.

41. An apparatus for translating text in electronic documents, the apparatus comprising a memory having a translation program stored therein, and a processor in communication with the memory, wherein the processor is configured to execute the program stored in the memory, the computer program being configured to:
determine at least one portion of text in a source document having the predetermined parameter associated therewith;
search in an electronic dictionary file to find a root entry corresponding to the predetermined parameter;
search in sub-root entries of the electronic dictionary to find an entry corresponding to the portion of text to be translated; and
search in children of the sub-root entries in the electronic dictionary to find a translation entry for textual content.

42. The apparatus of claim 41, wherein determining at least one portion of text having the predetermined parameter associated therewith further comprises indexing into the source code of an electronic document to locate text having an NLSID) associated therewith.

43. The apparatus of claim 41, wherein searching in the electronic dictionary file to find a root entry futer comprises indexing into the electronic dictionary file with an NLSID to find a root entry match.

44. The apparatus of claim 41, wherein searching in children of the sub-root entries fuither comprises indexing into the children of the sub-root entries with a preferred language parameter to find a match.
